(19) United States
(12) Patent Application Publication
(10) Pub. No.: US 2023/0163658 A1
(43) Pub. Date: May 25, 2023

(54) Can for an Electric Machine

(71) Applicant: Siemens Aktiengesellschaft, München (DE)

(72) Inventors: David Finck, Forchheim (DE); Felix Ntourmas, Erlangen (DE); Christian Seidel, Baiersdorf (DE)

(73) Assignee: Siemens Aktiengesellschaft, München (DE)

(21) Appl. No.: 17/921,695

(22) PCT Filed: Apr. 21, 2021
(86) PCT No.: PCT/EP2021/060309

§ 371 Date: Oct. 27, 2022

(30) Foreign Application Priority Data
Apr. 27, 2020 (DE) 10 2020 205 286.7

(51) Int. Cl. H02K 5/128; H02K 9/197

(52) U.S. Cl. CPC H02K 5/128; H02K 9/197

(57) ABSTRACT

Various embodiments of the teachings herein include a can for an electrical rotating machine and/or a liquid pump. The can may comprise a barrier layer including a barrier film and/or a barrier coating.

### CROSS-REFERENCE TO RELATED APPLICATIONS

This application is a U.S. National Stage Application of International Application No. PCT/EP2021/060309 filed Apr. 21, 2021, which designates the United States of America, and claims priority to DE Application No. 10 2020 205 286.7 filed Apr. 27, 2020, the contents of which are hereby incorporated by reference in their entirety.

### TECHNICAL FIELD

The present disclosure relates to electrical machines. Various embodiments of the teachings herein include cans for an electric motor, an electrical rotating machine, and/or a liquid pump.

### BACKGROUND

Increasing the power density of electrical rotating machines is of ever greater importance in the electrified field of mobility, for example in electrically driven vehicles such as buses, cars, utility vehicles, in trains and ships, and aircraft, because more powerful motors can save weight. There is therefore increasing attention on liquid-cooled electrical rotating machines, especially electric motors.

A factor that determines the dimensions in respect of the electrical power density of electric motor and generator is the waste heat produced, with the associated problems. One problem is, for example, the failure of the polymeric insulation of the winding coils in the laminated stacks of the stator of each electric motor. Therefore, the maximum temperature in the stator winding is also typically a particularly critical aspect in the case of development of higher power densities.

The reason for the trend toward liquid cooling lies in the higher waste heat flow achievable by means of liquid cooling, by comparison with gas-air cooling. It is generally the case in a liquid-cooled electric motor that it is the stator together with the laminated stacks and the winding coils present in polymeric casting compound that are cooled, not the rotor. The rotor, as a result of the lack of polymeric insulation, is less heat-sensitive than the laminated stacks of the stator that have a polymeric casting compound. In general, liquid cooling of an electric motor is preferably implemented on the outside of the stator because the interface to the rotor on the inside of the stator otherwise has to be sealed.

In general, the channels for the liquid cooling are thus on the outside of the stator. A problem is that the liquid-cooled cooling rings are on the outside of the laminated stack; therefore, this first has to be traversed completely by the heat flow in radial direction. As of recently, there are also electric motors having liquid cooling on the inside and outside of the stator. These electric motors include what is called a can.

The can surrounds the rotor of an electric motor or liquid pump, and separates the cooling fluid in the stator region from the rotating rotor or the rotating pump. In an electric motor, friction losses resulting from the viscosity of the cooling fluid would otherwise greatly hinder the rotation of the rotor.

The aim in the development of the can is to achieve a minimum wall thickness, since electrical losses from the electrical machine are thus kept to a minimum. The most successful cans to date have been made from fiber-reinforced composite materials, but these have relatively high wall thicknesses because the media-tightness of the fiber composite materials makes low wall thicknesses impossible for the production of cans.

The fiber-reinforced composite materials, also referred to hereinafter as fiber composite materials for short, by comparison with metals, have a lower media barrier against penetration by liquids, such as cooling fluid here, from the stator into the air gap. It is a feature of a fiber composite material that at least one matrix material and at least one type of reinforcing fibers embedded therein are present in the fiber composite material.

The aim is to keep electrical losses low by a very thin-wall design of the can. This increases the problem of media passage. As a result of production, especially by virtue of the heterogeneous physical construction of the fiber composite materials, microscopic and/or macroscopic defects occur in the fiber composite material, which lower liquid-tightness and increase the possibility of liquid permeation therethrough.

### SUMMARY

The teachings of the present disclosure describe a can for an electric motor, an electrical rotating machine, or a liquid pump or another tube under pressure stress, which does not have the disadvantages of the prior art, especially the low media-tightness of the materials and fiber composite materials used to date, and/or shows improved media-tightness compared to the materials used to date. For example, some embodiments include a can for an electrical rotating machine and/or a liquid pump, comprising at least one barrier layer in the form of a barrier film and/or in the form of a barrier coating.

In some embodiments, there is a hybrid construction with at least two at least partly overlapping layers.

In some embodiments, at least one barrier film is provided between the layers of a hybrid construction.

In some embodiments, the barrier layer is implemented in the form of at least one barrier film having surface coating.

In some embodiments, the barrier layer is implemented in the form of at least one multilayer barrier coating.

In some embodiments, a barrier layer is provided within the can.

In some embodiments, at least one barrier layer is provided on the surface, on the inside and/or outside of the can.

In some embodiments, a barrier film comprising an electrically nonconductive metal oxide and/or element organyl material as filler in a matrix material is provided.

In some embodiments, a barrier film comprising a polymer film is provided.

In some embodiments, a barrier film coated wholly or partly on one or both sides is provided.

In some embodiments, a barrier film of multilayer construction is provided.

In some embodiments, a barrier coating which is a high barrier coating composed of a resin filled with nanofiller is provided.

In some embodiments, a barrier coating applicable to the can as a liquid lacquer or as a powder coating is provided on one or both sides.

In some embodiments, a barrier coating producible on the can by means of gas phase deposition is provided.

In some embodiments, a thickness of the barrier layer, including possible coatings, in the range between 0.1 μm and a few millimeters is provided.

### DETAILED DESCRIPTION

A coating and/or a thin film made of media-tight material has good incorporability into a can made of fiber composite material, especially in the case of a hybrid construction composed of layers and/or laminate plies, and distinctly increases the media-tightness of a can produced from the fiber composite material, such that lower wall thicknesses of a can produced from fiber composite material should be achievable than to date. This has already been confirmed in first tests and studies. According to the construction of the can, the barrier layer may be incorporated onto and/or into the can over the full area or only in regions. Essentially, the barrier layer is sensibly formed over the full extent, at least over the full area, on the side(s) of the can under pressure stress.

In some embodiments, the barrier layer is incorporated into a hybrid structure composed of layers and/or laminate plies of a can. In some embodiments, a barrier layer is provided, for example, as interlayer within the layers of the hybrid construction. For example, the layers of the hybrid construction comprise layers with fiber reinforcement, especially with carbon-based fiber reinforcement, for example including high-modulus carbon fibers—i.e. with modulus of elasticity up to 500 GPa—and ultrahigh-modulus carbon fibers—i.e. with modulus of elasticity over and above 500 GPa. The position of these electrically conductive reinforcing fibers within the layers of the hybrid construction is preferably transverse to axial direction, especially at a setting angle in the range between 80° and 90° to the rotor axis. In this alignment, the disruptive eddy current effect on the electrical machine that results from the electrical conductivity of the material of the can is particularly low.

For example, the layers of the hybrid construction, additionally or alternatively to the abovementioned carbon-based fiber-reinforced layers, comprise those with oriented fiber reinforcement that lie at a setting angle between 20° and 70° to the rotor axis. These reinforcing fibers generally comprise fibers of zero or very low electrical conductivity, for example glass fibers, polymer fibers, ceramic fibers, especially those based on metal oxides, silicon carbide fibers, boron fibers, aramid fibers and/or other known reinforcing fibers, alone in any combination and/or mixtures.

In some embodiments, the barrier layer comprises a barrier film. This is present, for example, over the full area, such that it is provided, for example, as an interlayer in the interface region between two layers of the hybrid construction of the can. This barrier layer is correspondingly provided within the can.

In some embodiments, one or more barrier layer(s) may be provided on the outside and/or inside on the surface of the can. It is immaterial here whether the can has or does not have a hybrid construction composed of at least two layers. The barrier layer provided on the surface may take the form of at least one barrier film and/or at least one barrier coating. A suitable barrier film is, for example, a nonconductive metal oxide and/or ceramic film, for example a metal oxide film, a film of silicon carbide, a film of boron nitride and/or a carbon-based film made of graphenes, carbon flakes or the like.

A barrier film may, for example, also be a matrix material in the form of a polymer film that has been filled with filler particles, such as a film of thermoset or thermoplastic material, such as a PET (polyethylene terephthalate) film, a PP (polypropylene) film, a PI (polyimide) film, a PEEK (polyetheretherketone) film, a PPS (polyphenylene sulfide) film, a PPSU (polyphenylene sulfide) film, and a material combination, i.e. a film made from any copolymer, a film made from a polymer mixture or combination of different compounds and/or derivatives of the aforementioned polymers, and a blend of different copolymers and/or polymers.

The polymer film may also be composed of a filled material, especially filled with fine filler particles. The filler particles embedded in the matrix material of the barrier film may be made of any material, for example a metal oxide and/or element organyl material.

In some embodiments, the barrier film itself is still coated over the whole of its surface, i.e. on both sides, or over part, i.e. either in regions on one or two sides and/or only on one side. In some embodiments, there is a film structure in which a polymeric film with a single-sided or double-sided thin metal oxide and/or element organyl coating forms a barrier film or a layer of a barrier film.

An organometallic compound is what is called a metal organyl or element organyl. These are generally what are called “complexes” in which an organic—i.e. carbon-based—radical is bonded to one or more central atoms, which are generally metals. “Metal” in this context also refers to silicon and/or boron. A metal oxide compound is a compound of a metal with one or more oxygen atoms, generally having a strongly polar construction, especially also of the salt type.

For production of a barrier layer in the form of a coated barrier film, the latter is subjected to vapor deposition, for example, of a metal oxide and/or element organyl, or coated in turn, for example, by means of a PVD (physical vapor deposition) and/or CVD (chemical vapor deposition) process. By means of these processes, it is possible to produce ultrafine and ultrathin coatings of the barrier film, especially those with layer thicknesses in the single-digit nanometer range up to several hundreds of nanometers, especially also up to 10 micrometers.

A barrier film may also comprise multiple plies and, for example, comprise polymeric and ceramic, coated, single- or double-sidedly coated, plies. The incorporation of a barrier film into a can producible via wet winding, for example, is accomplished by simple inlaying of the film by wet winding, laminating, prepreg winding and/or pultrusion.

In some embodiments, the barrier layer comprises a single- or double-sided barrier coating applied to the surface of the can. The barrier layer as barrier coating is present in turn, for example, over the full area of the surface of the can, or in regions of the surface, which may relate either to the inside or outside of the can and to regions on one side of the can. The barrier layer as barrier coating of the can may additionally also have a multilayer structure like the barrier layer as barrier film.

It is likewise possible here for there to be a surface coating of a barrier layer in the form of a barrier coating with the same material structure as the coating of a barrier layer in the form of a barrier film. It is merely the thickness of this barrier coating—because it is applied to the surface—that is greater, for example, than the thickness of the coating of a barrier film. The layer thickness of a coating of a barrier coating is also again produced, for example, via gas phase deposition. By means of this process, it is possible to produce ultrafine and ultrathin coatings of the barrier film, especially those with layer thicknesses in the single-digit nanometer range up to several hundreds of nanometers, especially also from a few micrometers up to 10 micrometers.

In some embodiments, a barrier coating is, for example, what is called a high barrier coating on the surface of the inside and/or outside of a can. This is producible, for example, but not necessarily, via a gas phase deposition process. Formation of a high barrier coating can be accomplished, for example, using a matrix material, such as a resin, which, for example, forms the thermoplastic basis of the matrix material of a fiber-reinforced composite material. This matrix material is then correspondingly filled via particle modification for improvement of its barrier properties. The particle modification improves the barrier character of the resin and/or polymer which is open to diffusion. The finer the filler particles, i.e. the smaller and finer-grain, the better the barrier action thereof within the filled matrix material, resin and/or polymer. In some embodiments, nanoparticles are thus used here—possibly also in a blend with coarser-grain filler, for filling of the matrix material.

The filler material may again comprise ceramic, metal oxides, element organyl and/or polymeric particles, each of which may take the form of core-shell particles, of coated, partly coated and/or uncoated particles, of hollow bodies and/or of solid particles. These properties may be newly combined and/or adjusted by blends depending on the application, adjusted both in relation to the matrix and in relation to the can.

For example, the filler particles may comprise the following compounds, alone or in any blend and/or combination: aluminum oxide, zirconium oxide, titanium oxide, boron nitride, silicon oxide, silicon carbide, carbon-based fillers, graphenes, carbon flakes, carbon nanotubes, etc.

A matrix material in a barrier layer in the form of a barrier coating can be chosen just like the fiber composite materials; virtually all plastics are usable for this purpose, but useful materials in particular are inorganic materials that can also be used as lacquers. In particular, it is possible to use polymeric, hybrid polymeric and/or largely inorganic commercial lacquers, for example including silicatic lacquers, but avoiding brittle lacquers, especially ethyl silicate lacquers, and/or organosilicon lacquers, silazanes, siloxanes, silanes, ceramic green bodies as lacquers. The emphasis here is on the flexibility of the lacquers.

For such a barrier coating, a lacquer may be applied in liquid form to the inside and/or outside of the can by suitable wet-chemical coating and/or printing methods, such as spraying, knife coating, brushing, rolling, dipping, spin coating etc. This establishes layer thicknesses in the range from 0.1 μm to 10 mm, from 5 μm to 1 mm, or from 250 μm to 700 μm. On the other hand, it is also possible to apply a coating in the form of a powder coating, especially in the case of ceramic-based and/or highly filled coatings.

In some embodiments, the metal oxide- and/or element organyl-filled barrier coating may also be applied via gas phase deposition.

The thickness of a barrier layer, of a possibly coated barrier coating and/or of a likewise possibly coated barrier film is, for example, in the range from 20 μm up to a few millimeters, in the range of 20 μm to 1 mm, in the range between 20 μm and 800 μm, or in the range between 20 μm and 100 μm.

It is possible for the first time, without changing process conditions and production methods, in a simple manner, to generate media-tightness in a can produced from fiber composite material, based on such simple additional operating steps as painting with one or more lacquer layers and/or laminating. As a result, media-tight filler is introduced into ceramic and/or polymeric matrix materials and this embedded filler is then used to produce a coating and/or film which is mounted within and/or on the surface of the can, where it increases media-tightness by several times.

What is claimed is:

1. A can for an electrical rotating machine and/or a liquid pump, the can comprising:
a barrier layer including a barrier film and/or a barrier coating.

2. The can as claimed in claim 1, further comprising a hybrid construction with at least two at least partly overlapping layers.

3. The can as claimed in claim 2, further comprising a barrier film between the at least two layers.

4. The can as claimed in claim 1, wherein the barrier layer includes a barrier film with a surface coating.

5. The can as claimed in claim 1, the barrier layer includes a multilayer barrier coating.

6. The can as claimed in claim 1, wherein the barrier layer is disposed within the can.

7. The can as claimed in claim 1, wherein the barrier layer is disposed on an inside surface and/or an outside surface of the can.

8. The can as claimed in claim 1, wherein the barrier film comprises an electrically nonconductive metal oxide and/or element organyl material as filler in a matrix material.

9. The can as claimed in claim 1, wherein the barrier film comprises a polymer film.

10. The can as claimed in claim 1, wherein the barrier film coats at least in part one or both sides of the can.

11. The can as claimed in claim 1, wherein the barrier film comprises multiple layers.

12. The can as claimed in claim 1, wherein the barrier coating comprises a resin filled with nanofiller.

13. The can as claimed in claim 1, wherein the barrier coating is to the can as a liquid lacquer or as a powder coating on one or both sides of the can.

14. The can as claimed in claim 1, wherein the barrier coating is produced on the can by gas phase deposition.

15. The can as claimed in claim 1, wherein the barrier layer has a thickness in the range between 0.1 μm and a few millimeters.
